(19) United States
(12) Patent Application Publication
(10) Pub. No.: US 2005/0097262 A1
(43) Pub. Date: May 5, 2005

(54) System and method for monitoring and managing processor-internal memmories of a process-executing unit

(75) Inventors: Rainer Falsett, Babenhausen (DE); Matthias Jentsch, Einbeck (DE); Reinhard Seyer, Rodgau (DE)

Correspondence Address: FITCH, EVEN, TABIN & FLANNERY, P. O. BOX 65973, WASHINGTON, DC, 20035, US

(73) Assignee: DaimlerChrysler AG, Stuttgart (DE)

(21) Appl. No.: 10/972,088

(22) Filed: Oct. 25, 2004

(30) Foreign Application Priority Data
Oct. 23, 2003 (DE) 103 49 200.3

(51) Int. Cl. G06F 12/00

(52) U.S. Cl. 711/100

(57) ABSTRACT

A system and a method for managing and monitoring processor-internal memories of a process-executing unit or program unit, having a global stack memory area (1) for executing processes and sub-processes of a program sequence comprising different sub-processes, and a monitoring unit (2) for protecting and monitoring the address space of the stack memory area (1) between an upper limit (UL) and a lower limit (LL). The monitoring unit (2) has a separate, internal stack (3), which is adapted for storing a variable logical limit, e.g., the lower limit (LL), of the global stack memory (1) on each level of a nested arrangement of the program sequence in the transition between different processes. Data of a preceding process located on the other side of a stored variable logical limit, e.g., of a current process, are protected.

### CROSS REFERENCE TO RELATED APPLICATION

This application claims the priority of German Patent Application No. 103 49 200.3, filed on Oct. 23, 2003, the subject matter of which, in its entirety, is incorporated herein by reference.

### FIELD OF THE INVENTION

The invention relates to a system and a method for managing and monitoring processor-internal memories of a process-executing unit. More particularly, the present invention relates to a system for managing and monitoring processor-internal memories of a process-executing unit having a global stack memory area for executing processes and sub-processes of a program sequence comprising different sub-processes, and a monitoring unit for protecting and monitoring the address space of the stack memory area between an upper limit (UL) and a lower limit (LL), The present invention additionally relates to a method for managing and monitoring processor-internal memories of a process-executing unit, in which data of a process execution of program and sub-program processes are stored in a global stack memory area, with the address space of the stack being monitored for the purpose of maintaining a fixed limit (UL) and a variable logical limit (LL).

### BACKGROUND OF THE INVENTION

The invention relates more particularly to managing and monitoring memory areas that are primarily provided for executing sub-programs within a program sequence. The term sub-program is used here to designate any type of sub-processes that may occur during a program sequence. Sub-programs also especially encompass functions and procedures that are already implemented or specified in, for example, the programming language PASCAL. When a change in task occurs, this memory area may serve in transferring additional variables. Memories of this type, which are conventionally referred to as a stack memory area, or simply “stack,” store the return addresses of sub-programs. The stack can also store dynamic variables to be transferred between programs and sub-programs.

The memory size of these stack memory areas is fixed between a logical upper limit and a logical lower limit. Stack memories function in accordance with the LIFO (Last In, First Out) principle: The data that were stored last are the first to be read out. This process is organized by a so-called pointer, which represents an address and is stored in a register provided expressly for the pointer. The pointer is generally referred to as a stack pointer. The present invention particularly relates to a global, processor-internal stack that serves as a common memory area for all program segments of a program-processing unit. The common stack implements the jump address and the data exchange of individual program segments, processes and sub-programs. If a new process is fetched, the execution of the already-active process is interrupted and the information regarding the status of the function and the program-processing unit, such as the current address values or register values, is stored in the stack. When the new process has ended, the data stored in the stack can be redirected back to the previous process and the former status can be reinstated.

An associated problem is that erroneous accesses to the stack can cause errors if, for example, individual program segments in the used stack area are not protected from erroneous use by other program segments. In addition to erroneous accesses to data stored in the stack, errors may also occur when the memory area of the stack is not large enough, and its upper or lower limit is violated. The program developer typically determines the stack size by defining a fixed address space when the program is translated. It is known to secure the address space or memory area of the stack by monitoring the designated upper and lower limits. This limit monitoring is effected, for example, by an operating system function or processor-internal hardware registers.

It is also known to monitor the defined limits of a stack continuously by comparing current stack addresses to the values of two registers provided specifically for them. U.S. Pat. No. 4,376,297 describes a stack management system of this type. This system of monitoring the limits of a stack memory area, however, does not address a direct, erroneous access within the limits, such as those caused by safety commands of registers, mostly referred to as “push” and “pop” commands, that do not correspond in number. The known method of monitoring the memory area of stack memories is also not protected from unauthorized access or overwriting of data areas within the limits of the stack address space that are crucial to function.

A problem associated with the known solutions for managing stack memory areas is that, in nested processes, there is no guaranteed protection of the data and return addresses of the preceding process that are remaining in the stack against activities of the processes displacing them. Because the return addresses of the nested processes are also stored in the stack, the entire system becomes non-functional if the addresses are destroyed. The system enters an unforeseeable state, and can fail completely. Another problem affecting known systems for managing and monitoring stacks is that, with nested processes, errors may cause the process that has just ended to leave data in the stack that should have been removed from the stack prior to the end of the process. The subsequent process may interpret these data as its own data that were stored before the displacement, and will proceed erroneously because of the incorrect data.

### SUMMARY OF THE INVENTION

In contrast to the above, it is the object of the present invention to provide a system and a method for managing and monitoring processor-internal memories of a process-executing unit having a global stack memory area, with the system and method assuring differentiated, effective protection of memory areas between individual processes or sub-programs in any situation.

This object generally is accomplished according to a first aspect of the invention by a system, managing and monitoring processor-internal memories of a process-executing unit having a global stack memory area for executing a program sequence that includes programs, sub-programs and sub-processes, and a monitoring unit for protecting the address space of the stack memory area between an upper and a lower limit, with the monitoring unit having a separate, internal stack or monitoring register, which is adapted to store a variable logical limit of the global stack memory area at each nesting level of the program sequence during shifts between different processes or functions.

The monitoring of the outer limits of the stack is based on the concept of monitoring with a variable logical limit. This logical variable limit can be embodied variably in the upper limit as well as the lower limit. The ensuing description treats an embodiment in which the lower limit is embodied as a variable limit, without any general limitations.

The variable logical limit of the global stack memory area is adapted corresponding to the respective process or function, that is, it is set high and is carried along through the nesting of various processes or sub-programs. Therefore, only the memory area of the global stack that is located between this variable logical limit and the address of the total stack area that has been established as the outer limit is available for a process. The variable logical limit of the stack memory area of the global stack is established for each respective program level of the sub-programs and sub-processes, and stored in an internal, separate monitoring memory or stack. The storage of the variable logical limit allows the remaining memory areas and data of the previous process located within this new limit to be protected against overwriting.

The storage of the respective lower logical limit for different processes on different levels of a program sequence permits access to the preceding process at any time. For this purpose, it is only necessary to access the internal stack in which the respective lower limits or their addresses are stored. The protected data can be utilized to re-implement the method at the secured point in the program sequence.

The invention ensures that all processes—with the exception of the current process—are denied access to memory areas between the variable logical limit, e.g., the lower limit and the defined or fixed limit, e.g., the upper limit. This feature guarantees that, over the entire program sequence of the program-executing unit, processes or functions that are lower in the nesting structure cannot destroy their own return address or adversely influence data or return addresses of higher-up processes. The invention thus provides a differentiated memory protection that permits a more efficient management and monitoring of stack memory areas that is protected from any type of disturbance.

In accordance with an advantageous embodiment of the invention, the monitoring unit can store the current logical limit (lower) of the global stack memory area in the internal stack during a transition to a new process, and fetch it in the event of a return to the preceding process. Thus, the respective variable (lower) logical limit, which can vary according to the process, can be stored in the internal stack and repeatedly displaced further down as the sequence continues to a subsequent process. Thus, even with heavily-nested program structures, a return to previous processes is assured without erroneous data or incorrect data being read, or the information needed for a return being lost.

In accordance with a further advantageous embodiment of the invention, the monitoring unit has means for protecting data below the current lower logical limit of the global stack. The memory area of the global stack that is provided with data from the previous process therefore cannot be read and/or overwritten. The data are only available again upon a return to this process. The current process can only read and store data within its newly established variable (lower) limit and the fixed (upper) limit set for the entire program. The means for protecting the data can be embodied as hardware.

The monitoring means comprise a comparator circuit that compares the current value of the stack pointer to the variable logical limits stored in the internal stack. If the address of the stack pointer is located inside the memory area designated by the area limits, the process sequence is running correctly. If the current address of the stack pointer lies outside of the designated memory limits, the ongoing process is interrupted and the system can return to the previous process, or a special function can be initiated.

In accordance with another advantageous embodiment of the invention, a return device is provided for reverting from a current process to the respective preceding process with the use of the variable logical limit stored in the internal stack and the respective protected data of the previous process. The return address of the fetching program serves as a secure return address or operating point at which a process can be resumed. Even with heavily-nested program sequences having several sub-programs and sub-processes, this feature assures a stable starting point for resuming the program at a previous process step. The corresponding information, data and address values are reliably stored, because the respective lower logical limits of the global stack can be variably stored and monitored in the internal stack.

A further advantageous embodiment of the invention includes a time-monitoring unit that is coupled to the return device for permitting an interruption and a return to the return address stored in the internal stack and data of the previous process after an established length of time in the event of a serious error in a process of a program or sub-program. If, for example, a serious error occurs in a process of a sub-program, the time-monitoring unit can initiate the interruption following a predetermined length of time, and the program sequence is resumed at the stored and protected return address of the previous process. The memory areas in the stack memory that are internal to the process are protected, and it is advantageously possible to recognize an erroneous sub-program execution and interrupt it, then continue the program sequence at a secure point. The system according to the invention for managing and monitoring stack memory areas greatly increases the operating reliability of program sequences.

The above object generally is achieved according to a second aspect of the invention by a method for managing and monitoring processor-internal memories of a process-executing unit including storing data of a process execution of programs and sub-programs in a global stack memory area, with the address space or memory area of the stack being monitored for the purpose of maintaining an upper and a lower limit. Additionally, and in accordance with the invention, during the shift to a new process within the program, or to another sub-program, the current variable logical limit of the global stack is stored in an internal, separate stack and included in the following program sequence, and the data of the preceding process located on the other side of the new variable logical limit of the new, current process are protected. Both the upper and lower limits can be embodied as variable logical limits. The ensuing description treats an embodiment in which the lower limit is embodied as a variable limit, without any general limitations.

With the variable logical limit being the lower limit, the data of the previous process that lie beneath the new logical lower limit of the new process are protected from reading and/or overwriting, which creates a sort of variable stack memory area in the sense that the lower logical limit of the stack is variable and can be monitored over the entire program sequence. This effectively prevents an error in the program sequence due to an erroneous access within the limits of the global stack area. The current process can only access the stack area that was defined for it and has the new lower limit, and can store and read out data. The monitoring of the stack memory area is therefore assured on each program level without the consequence of a complete interruption of the program because of erroneous accesses due to violations of the stack-area limits or other program errors. The program sequence is simply resumed at the previous processes or functions with the aid of the stored lower logical limit and the data of this process.

In accordance with a further advantageous embodiment of the invention, the previous lower logical limits of a process are used as the return address for the current process in the global stack when a program error occurs. This ensures that the program is resumed at a stable location. Like the global stack, the internal stack serving in the monitoring and management of the respective variable, logical limits operates according to the LIFO principle—that is, the lower logical limit of the preceding process that was stored last is the first to be used if a return is necessary in the event that a current process must be interrupted. Thus, the method of the invention not only assures a stable program run, but permits the recognition and automatic treatment of problems over the course of sub-programs and processes.

In accordance with a further advantageous embodiment of the invention, a new lower logical limit of the global stack is established for a new process, and the memory area beneath the new limit is protected from reading and overwriting by the new process. The current process can therefore only access the memory area of the global stack that has been defined for it, that is, the area within the upper limit defined in the overall program sequence and the variable lower limit, depending on the process or function. In a return, the data of the preceding process that are located outside of the limits that have been defined for the current process are therefore not lost. The data can advantageously be used in the continuation and resumption of the program.

In accordance with a further advantageous embodiment of the invention, an ongoing process is interrupted after a specified length of time, and the system reverts to the preceding process by means of the data stored in the internal monitoring stack and the respective lower logical limit of the preceding process; the program then continues with this process. The specified length of time after which the system reverts to a previous process can be variably set. As a result, if a serious error occurs within a process sequence, even if the error is not recognized directly by the monitoring unit, the system nevertheless does not revert to the previous process from which the program can be resumed in a stable manner. The method according to the invention permits a differentiated monitoring and protection of stack memories of data-processing machines. The differentiated memory protection results in a greater stability of process sequences. Individual sub-programs and processes of the sub-programs can be executed in arbitrary nested program levels without the system completely failing in the event of errors in these program levels.

Further advantages and features of the invention ensue from the following detailed description, in which the invention is explained in greater detail with respect to the exemplary embodiment illustrated in the attached drawings.

### BRIEF DESCRIPTION OF THE DRAWINGS

FIGS. 1a, 1b, 1c and 1d present various states during shifts between a plurality of processes of a program sequence, thereby schematically illustrating the memory areas and stored variables of a global stack and a monitoring stack in accordance with an exemplary embodiment of the present invention.

### DETAILED DESCRIPTION OF THE INVENTION

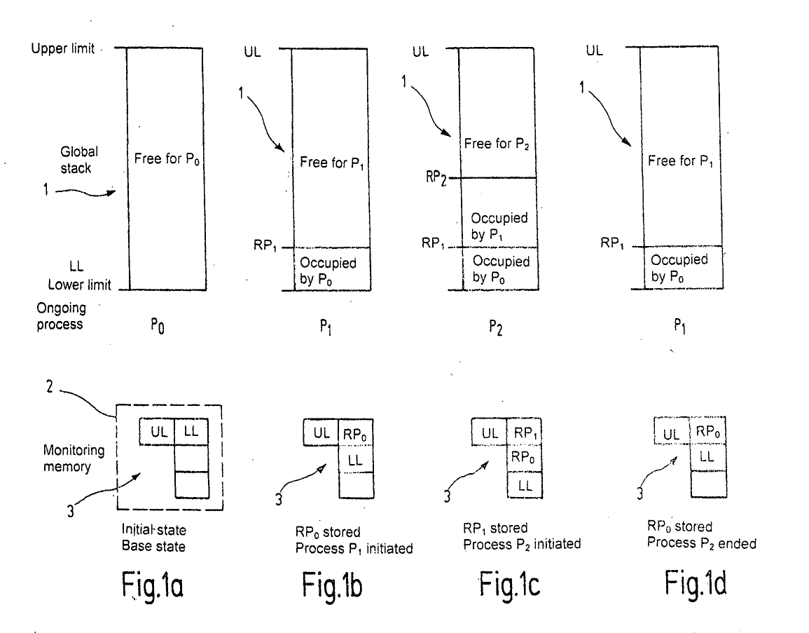

FIG. 1a is a schematic representation of the base state of the system according to the invention for monitoring and managing a global stack. The global stack 1 has an upper limit UL, which is specified by the programmer, and a lower limit LL, the limits having respective addresses that define a free memory area for the current process P₀ between them. In accordance with the invention, in addition to global stack 1, an internal, separate stack 3 is provided in a monitoring unit 2. In the initial state, internal stack 3, or monitoring stack, stores the respective upper limit UL and the lower limit LL corresponding to RP₀ of global stack 1. When the ongoing process P₀ is interrupted and the transition is made to the next process, such as a sub-program, process P₁ begins (FIG. 1b). In this shift from process P₀ to P₁, the current stack pointer or current lower limit RP₀ of the global stack 3 is entered into an internal stack memory 3 of the monitoring unit 2 and stored. The data are required for the return to process P₀. The present lower logical limit RP₀ displaces the value LL in monitoring stack 3, with the value being set at one position lower and stored. This new logical lower limit RP₀ is used to continue the monitoring of the memory area of global stack 1. Value RP₀ is therefore the new, permissible logical lower limit for process P₁. The preceding values of UL are maintained as the upper limit UL of global stack 1 for the ongoing process P₁. Regardless of the ongoing process, the specified value or address is always maintained as upper limit UL. The ongoing process P₁ can no longer read the data and the return address of preceding process P₀ from global stack 1. Additionally, the current process P₁ cannot overwrite the data in this state (FIG. 1b), because it is prevented from doing so by the hardware unit, for example. The data of the previous process P₀ are therefore reliably protected in global stack 1.

The same procedure is repeated in the transition from the current process P₁ (FIG. 1b) to process P₂ (FIG. 1c), with the latter displacing the current process P₁. Again, the current lower logical limit RP₁ is stored in monitoring stack 3 of monitoring unit 2, and it displaces the preceding limit or stack pointer RP₀, which is shifted down to the next position. The current process, in this instance P₂, has complete access to global stack 1 above the newly established lower logical limit RP₂. The process cannot, however, access the protected lower area below this logical limit. The respective lower logical limit is redefined by each new sub-program process P₁, P₂ When process P₂ is ended, the old limits for global stack 1 are reset by internal stack 3, in which they are stored (FIG. 1d). During a return to a previous process, such as with the occurrence of an error in the current process sequence, the lower logical limit that was stored last is fetched from internal stack 3 and stored as the lower limit in global stack 1 (LIFO principle). The memory areas are thus specifically adapted to respective sub-processes, and permit a flexible adaptation and tracking of the lower limit and storage of areas that are crucial for a return on all levels of a program sequence.

In summary, the advantage of the solution offered by the invention lies in the effective protection of processor-internal stack areas of an internal memory, and in the capacity to recognize the erroneous sequence of a sub-program at any time, interrupt the program and then continue from a secure point further along in the sequence of a program.

All of the features and elements presented in the description and the subsequent claims, and illustrated in the drawings, can be realized individually as well as in arbitrary combinations with one another.

It will be appreciated that the above description of the present invention is susceptible to various, modifications, changes and adaptations, and the same are intended to be comprehended within the meaning and range of equivalents of the appended claims.

1. A system for managing and monitoring processor-internal memories of a process-executing unit, including: a global stack memory area for executing processes and sub-processes of a program sequence comprising different sub-processes; a monitoring unit for protecting and monitoring the address space of the stack memory area between an upper limit and a lower limit; and a separate, internal stack disposed in the monitoring unit, with the separate, internal stack being adapted for storing at least one of the upper and lower limits as a variable logical limit of the global stack memory on each level of a nested arrangement of the program sequence during the transition between different processes.

2. The system according to claim 1, wherein the monitoring unit stores the respective, current lower logical limit of the global stack as the variable limit in the separate internal stack during a transition to a new process and fetches the limit during a return to a preceding process.

3. The system according to claim 2, wherein the monitoring unit includes means for protecting data below the respective, current lower logical limit of the global stack.

4. The system according to claim 2, including, a return device for returning from a current process to the preceding process using the lower logical limit stored in the internal stack as a return address, as well as using the protected data of the preceding process.

5. The system according to claim 4, further including a time-monitoring device coupled to an address device to permit a process interruption after a fixed period of time in the event of a serious error in a process of a sub-program, and a return to the return address stored in the internal stack and the data of the preceding process.

6. The system according to claim 1 wherein the global stack memory operates according to the LIFO principal.

7. A method for managing and monitoring processor-internal memories of a process-executing unit comprising: storing data of a process execution of program and sub-program processes in a global stack memory area of the process-executing unit; monitoring the address space of the stack memory for the purpose of maintaining a fixed limit and a variable logical limit; during the transition to a new process within the program, storing a current limit of the global stack as a variable logical limit in an internal, separate stack and included in the following programs sequence; and protecting the data of the preceding process located on the other side of the new variable logical limit of the new, current process.

8. The method according to claim 7, further including using the preceding variable logical limit of a process as a return address in the global stack in the event of a program error in the ongoing process.

9. The method according to claim 7, wherein: the step of storing includes utilizing the lower limit as the variable logical limit, and specifying a new lower logical limit of the global stack of a current process within the limits of the preceding process; and the step of protecting includes protecting the data of the global stack memory beneath the new lower logical limit from being read or overwritten by the new process.

10. The method according to claim 9, further including interrupting an ongoing process after a specific period of time, and returning to the immediately preceding process using the stored data and the lower logical limit stored in the internal stack; and then subsequently continuing of the program sequence with the immediately preceding process.

11. The method according to claim 7, further including operating the global stack memory according to the LIFO principal.
